(19) United States
(12) Patent Application Publication
(10) Pub. No.: US 2026/0105186 A1
(43) Pub. Date: Apr. 16, 2026

(54) Digital Identity System and Operation Method of Digital Identity System

(71) Applicant: SUNGSHIN WOMEN’S UNIVERSITY R&DB FOUNDATION, Seoul (KR)

(72) Inventors: Il-Gu LEE, Seoul (KR); Sohyun PARK, Seoul (KR); Gee-Hee YUN, Seoul (KR); Kyoung-Jin KIM, Hanam-si Gyeonggi-do (KR)

(73) Assignee: SUNGSHIN WOMEN’S UNIVERSITY R&DB FOUNDATION, Seoul (KR)

(21) Appl. No.: 18/913,265

(22) Filed: Oct. 11, 2024

(30) Foreign Application Priority Data
Oct. 12, 2023 (KR) 10-2023-0136268
Mar. 7, 2024 (KR) 10-2024-0032631

(51) Int. Cl. G06F 21/62; H04L 9/08

(52) U.S. Cl. CPC G06F 21/6254; H04L 9/0869

(57) ABSTRACT

Provided are a digital identity system and an operation method of the digital identity system. The digital identity system may include a first node configured to generate a de-identified unique identification value for a data subject based on the data subject's unique identification value and an identity generation sequence received from a data subject terminal, and generate a first digital identity (ID) based on the de-identified unique identification value of the data subject, and a seed value that is generated according to a preset criterion, and a second node configured to receive, from the first node, the de-identified unique identification value of the data subject, and the seed value, and generate a second digital ID based on the de-identified unique identification value of the data subject, and the seed value.

### CROSS-REFERENCE TO RELATED APPLICATIONS

This application is based on and claims priority under 35 U.S.C. § 119 to Korean Patent Application No. 10-2023-0136268, filed on Oct. 12, 2023, and to Korean Patent Application No. 10-2024-0032631, filed on Mar. 7, 2024, in the Korean Intellectual Property Office, the disclosure of which is incorporated by reference herein in its entirety.

### BACKGROUND

### 1. Field

The present disclosure relates to a digital identity system in which a plurality of nodes share a de-identified unique identification value of a data subject to generate respective digital identities (IDs), and update the digital IDs at every preset period, thereby preserving the privacy of the digital IDs, and an operation method of the digital identity system.

### 2. Description of the Related Art

The use of digital identities (IDs) has explosively increased across various fields due to the spread of COVID-19. In particular, Quick Response (QR) codes have been widely used as digital IDs to maintain visit records for tracking COVID-19 cases. These digital IDs have been utilized for purposes beyond merely approving and authenticating access rights for specific individuals.

However, currently, due to a lack of compatibility of digital IDs among service providers in various identity verification service environments, users face the inconvenience of having to redundantly obtain digital IDs issued by a plurality of service providers as needed. In addition, incidents of data breaches involving digital IDs may lead to users being implicated in illegal activities, and hacking, theft, or loss of devices storing digital IDs may result in financial damages.

### SUMMARY

According to an embodiment of the present disclosure, there may be a digital identity system and an operation method of the digital identity system, for enabling the generation of digital identity (ID) at each node while limiting the leakage of a unique identification value of a data subject that is not encrypted, by allowing a first node to generate a de-identified unique identification value of the data subject by encrypting the unique identification value of the data subject that is received from a data subject terminal, and generate a first digital ID based on the de-identified unique identification value of the data subject, and by allowing a second node to generate a second digital ID based on the de-identified unique identification value of the data subject shared by the first node.

According to an embodiment of the present disclosure, the first and second nodes update their first and second digital IDs at every preset period, respectively, thereby enabling each node to maintain a valid digital ID, and preventing a chain of personal information leaks even when a previous digital ID is leaked.

According to an embodiment of the present disclosure, the second node receives the first digital ID updated by the first node at a particular time point, and determines, when the second digital ID updated by the second node at a particular time point coincides with the first digital ID, that the second digital ID is valid, and thus provides service information supported by the second node (or another node), to a data subject terminal associated with the second digital ID, thereby enabling the data subject to use the service information.

In addition, according to an embodiment of the present disclosure, as a unique identification value of a data subject provided by a data subject terminal includes both personally identifiable information and a service identification sequence for identifying a service, the first node generates, based on the unique identification value of the data subject, digital IDs differently for respective services, thereby significantly reducing the possibility of tracing a digital identity of the data subject.

Technical objectives of the present disclosure are not limited to the foregoing, and other unmentioned objectives or advantages of the present disclosure would be understood from the following description and be more clearly understood from the embodiments of the present disclosure. In addition, it would be appreciated if the objectives and advantages of the present disclosure were implemented by means provided in the claims and a combination thereof.

Additional aspects will be set forth in part in the description which follows and, in part, will be apparent from the description, or may be learned by practice of the presented embodiments of the disclosure.

A digital identity system according to an embodiment of the present disclosure may include a first node configured to generate a de-identified unique identification value of a data subject based on a unique identification value of the data subject and an identity generation sequence which is received from a data subject terminal. The first node then generates a first digital ID based on the de-identified unique identification value of the data subject, and a seed value that is generated according to a preset criterion, and a second node configured to receive, from the first node, the de-identified unique identification value of the data subject, and the seed value, and generate a second digital ID based on the de-identified unique identification value of the data subject, and the seed value.

An operation method of a digital identity system according to an embodiment of the present disclosure may include, by a first node in the digital identity system, generating a de-identified unique identification value of a data subject based on a unique identification value of the data subject and an identity generation sequence which are received from a data subject terminal, and generating a first digital ID based on the de-identified unique identification value of the data subject, and a seed value generated according to a preset criterion, and by a second node in the digital identity system, receiving, from the first node, the de-identified unique identification value of the data subject, and the seed value, and generating a second digital ID based on the de-identified unique identification value of the data subject, and the seed value.

Other aspects, features, and advantages other than those described above will become apparent from the following drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of a digital identity system according to an embodiment of the present disclosure;

FIG. 2 is a diagram illustrating an example of a configuration of a first node and a second node both included in a digital identity system, according to an embodiment of the present disclosure;

FIG. 3 is a diagram illustrating a structure for generating information used in a digital identity system, according to an embodiment of the present disclosure;

FIG. 4 is a diagram for describing an example of generating a de-identified unique identification value of a data subject in a digital identity system, according to an embodiment of the present disclosure;

FIG. 5 is a message flow diagram for describing an example of an operation method of a digital identity system, according to the present embodiment;

FIG. 6 is a message flow diagram for describing another example of an operation method of a digital identity system, according to the present embodiment;

FIG. 7 is a message flow diagram for describing another example of an operation method of a digital identity system, according to the present embodiment;

FIG. 8 is a message flow diagram for describing another example of an operation method of a digital identity system, according to the present embodiment; and

FIG. 9 is a flowchart of an operation method of a digital identity system according to an embodiment of the present disclosure.

### DETAILED DESCRIPTION

Reference will now be made in detail to embodiments, examples of which are illustrated in the accompanying drawings, wherein reference numerals refer to elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any combinations of one or more of the items listed in the associated list. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the accompanying drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. The singular expression also includes the plural meaning as long as it is not inconsistent with the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Terms such as “first” or “second” may be used to describe various elements, but the elements should not be limited by the terms. These terms are used only to distinguish one element from another.

In addition, as used herein, the term “unit” may be a hardware component such as a processor or a circuit, and/or a software component executed by a hardware component such as a processor.

Hereinafter, embodiments of the present disclosure are described in detail with reference to the accompanying drawings, and the same or corresponding components are denoted by the same reference numerals when described with reference to the accompanying drawings, and thus, redundant descriptions thereof are omitted.

In the following embodiments, terms such as “first,” “second,” etc., are used only to distinguish one component from another, and such components must not be limited by these terms.

In the following embodiments, the singular expression also includes the plural meaning as long as it is not inconsistent with the context.

In the following embodiments, the terms “comprises,” “includes,” “has,” and the like used herein specify the presence of stated features or components, but do not preclude the presence or addition of one or more other features or components.

When a certain embodiment may be differently implemented, particular operations may be performed differently from the sequence described herein. For example, two processes, which are successively described herein, may be substantially simultaneously performed, or may be performed in a process sequence opposite to a described process sequence.

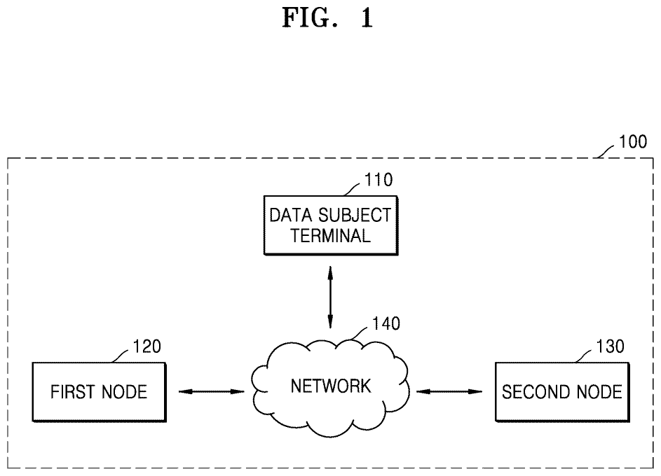

FIG. 1 is a diagram illustrating an example of a digital identity system according to an embodiment of the present disclosure.

Referring to FIG. 1, a digital identity system 100 may include a data subject terminal 110, a first node 120, a second node 130, and a network 140. The digital identity system 100 may further include an identification sequence granting device (not shown).

The data subject terminal 110 may receive, from a data subject (e.g., an individual or a user), personally identifiable information for identifying the data subject. Here, personally identifiable information may be provided by a particular organization (e.g., an administrative agency) or a particular company to identify an individual, such as a resident registration number, a social security number, an email address, or an identifier (ID).

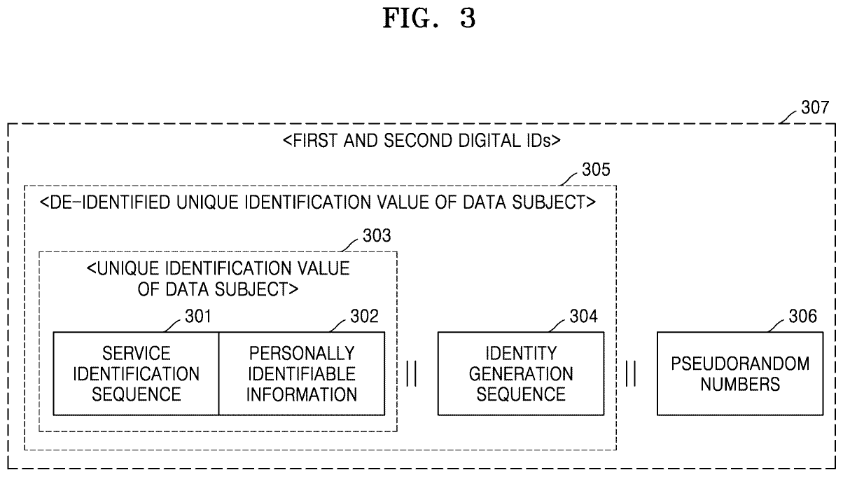

The data subject terminal 110 may obtain a service identification sequence 301 and generate a unique identification value 303 of the data subject based on the service identification sequence 301 and personally identifiable information 302 (see FIG. 3). At this time, the data subject terminal 110 may receive information about at least one of a service specified by the data subject, and an institution (or company) and an application associated with the service, and transmit a service identification sequence request together with the received information, to the identification sequence granting device. The data subject terminal 110 may obtain a service identification sequence by receiving, from the identification sequence granting device, a service identification sequence generated based on the information according to a preset first condition, or by generating a service identification sequence based on the information according to a preset second condition.

The data subject terminal 110 may generate a unique identification value of the data subject by concatenating the service identification sequence with the personally identifiable information, so as to expand the personally identifiable information, thereby overcoming the limited use of personally identifiable information (e.g., limited use to a specific country, a specific service, or a specific application) and increasing the range of identification values.

The data subject terminal 110 may generate an identity generation sequence based on a preset method (e.g., a random method), and transmit the unique identification value of the data subject, and the identity generation sequence to the first node 120. Here, there may be one or more identity generation sequences. That is, the identity generation sequence may be a single or multi-identity generation sequence including a plurality of identity generation sequences.

The data subject terminal 110 may include a communication terminal capable of performing functions of a computing device, and may be, but is not limited to, a desktop computer, a smart phone, or a notebook computer operated by a user, a tablet personal computer (PC), a smart television (TV), a mobile phone, a personal digital assistant (PDA), a media player, a microserver, a global positioning system (GPS) device, an e-book terminal, a digital broadcasting terminal, a navigation device, a kiosk, an MP3 player, a digital camera, a home appliance, or other mobile or non-mobile computing devices. The data subject terminal 110 is not limited to the above examples, and a terminal capable of web browsing may be used without limitation.

The first node 120 may be a digital identity generation node, and may receive the unique identification value of the data subject, and the identity generation sequence, from the data subject terminal 110.

The first node 120 may generate a de-identified unique identification value of the data subject, based on the unique identification value of the data subject, and the identity generation sequence. In addition, the first node 120 may generate a seed value according to a preset criterion, and generate a first digital identity (ID) corresponding to the data subject based on the de-identified unique identification value of the data subject, and the seed value. At this time, the first node 120 may generate pseudorandom numbers based on the seed value, and generate the first digital ID based on the de-identified unique identification value of the data subject, and the pseudorandom numbers.

The first node 120 may store the first digital ID in a memory, by matching the first digital ID to the personally identifiable information of the data subject (or the unique identification value of the data subject). The first node 120 may transmit, to the second node 130, the de-identified unique identification value of the data subject, and the seed value, so as to provide an environment in which the second node 130 may generate a second digital ID corresponding to the data subject. At this time, by transmitting the de-identified unique identification value of the data subject to the second node 130, the first node 120 may limit leakage of the unique identification value of the data subject that is not encrypted, and allow the de-identified unique identification value of the data subject to be shared with the second node 130. In addition, the first node 120 may share the seed value with the second node 130 by transmitting the seed value to the second node 130, such that the second node 130 may utilize the seed value to generate pseudorandom numbers to be used for generating a second digital ID at a later time. The sharing of the seed value may be based on that, when a seed is input for generating pseudorandom numbers, the pseudorandom numbers are always generated with the same pattern or rule. That is, pseudorandom numbers have randomness and unpredictability and are irreproducible; however, when a fixed seed value is input for generating pseudorandom numbers, it is possible to generate reproducible pseudorandom numbers.

The second node 130 may be a digital identity usage node and may receive, from the first node 120, a de-identified unique identification value of a data subject, and a seed value. The second node 130 may generate a second digital ID corresponding to the data subject based on the de-identified unique identification value of the data subject, as well as the seed value. At this time, the second node 130 may generate pseudorandom numbers based on the seed value, and generate a second digital ID based on the de-identified unique identification value of the data subject, and the pseudorandom numbers.

The second node 130 may store the second digital ID in a memory, by matching the second digital ID to the personally identifiable information of the data subject (or the unique identification value of the data subject).

The first node 120 and the second node 130 may automatically update the first and second digital ID at every preset period, respectively, thereby preventing a chain of personal information leaks even when a previous digital ID is leaked.

In an embodiment, the second node 130 may transmit, to the first node 120, a verification request for the second digital ID stored in the memory of the second node 130, receive, from the first node 120 as a response to the verification request, the first digital ID that is updated at a particular time point (e.g., the current time), and when the second digital ID updated at a particular time point by the second node 130 coincides with the updated first digital ID, determine that the second digital ID is valid. Based on determining that the second digital ID is valid, the second node 130 provides the data subject terminal 110 with service information supported by the second node 130 (or another node), to allow the data subject to use the service information.

In an embodiment, the data subject terminal 110 may receive, from the data subject (e.g., an individual or a user), the number of identities together with personally identifiable information, and generate as many identity generation sequences as the number of identities. For example, when the number of identities is not input or when 1 is input as the number of identities, the data subject terminal 110 may generate one identity generation sequence. When 5 is input as the number of identities, the data subject terminal 110 may generate five identity generation sequences.

The first node 120, which is configured to receive an identity generation sequence from the data subject terminal 110 and generate a first digital ID based on the identity generation sequence, may generate as many first digital IDs as the number of identity generation sequences. For example, the first node 120 may generate one first digital ID when there is one identity generation sequence, and may generate five first digital IDs (e.g., first digital ID_#1 to first digital ID_#5) when there are five identity generation sequences. The number of first digital IDs may be set to the number of identity generation sequences due to management costs, complexity, etc.

The network 140 may connect to at least one of the data subject terminals 110, the first node 120, and the second node 130. The network 140 may include, for example, a wired network such as a local area network (LAN), a wide area network (WAN), a metropolitan area network (MAN), an integrated services digital network (ISDN), or a wireless network such as a wireless LAN (WLAN), code-division multiple access (CDMA), or satellite communication, but the present disclosure is not limited thereto. In addition, the network 140 may transmit and receive information using short-range and/or long-range communication. Here, the short-range communication may include Bluetooth, radio-frequency identification (RFID), Infrared Data Association (IrDA), ultra-wideband (UWB), ZigBee, and wireless fidelity (Wi-Fi), and long-range communication may include code-division multiple access (CDMA), frequency-division multiple access (FDMA), time-division multiple access (TDMA), orthogonal FDMA (OFDMA), and single-carrier FDMA (SC-FDMA).

The network 140 may consist of interconnected network elements, such as hubs, bridges, routers, or switches. The network 140 may include one or more connected networks, for example, a multi-network environment, including a public network, such as the Internet, and a private network, such as a secure corporate private network. Access to the network 140 may be provided via one or more wired or wireless access networks.

Furthermore, the network 140 may support controller area network (CAN) communication, vehicle-to-infrastructure (V2I) communication, vehicle-to-everything (V2X) communication, wireless access in vehicular environment (WAVE) communication, and an Internet-of-Things (IOT) network and/or 5G communication that allows distributed components, such as objects, to exchange and process information.

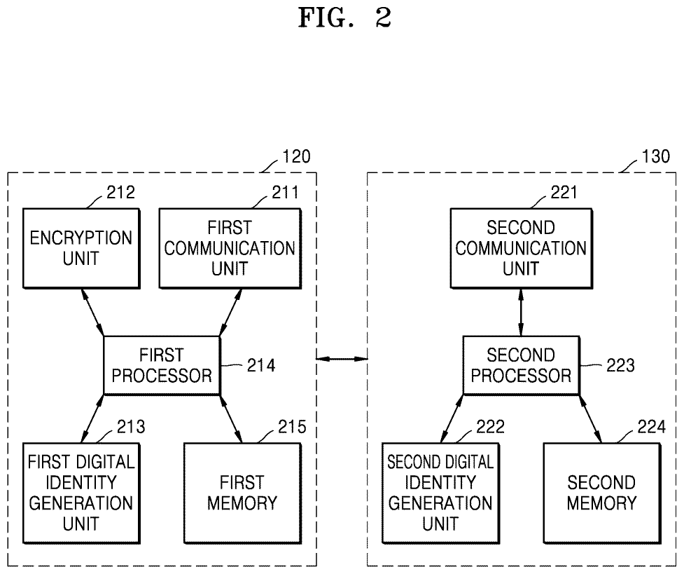

FIG. 2 is a diagram illustrating an example of a configuration of a first node and a second node both included in a digital identity system, according to an embodiment of the present disclosure.

Referring to FIG. 2, the first node 120 may include a first communication unit 211, an encryption unit 212, a first digital identity generation unit 213, a first processor 214, and a first memory 215.

The first communication unit 211 may transmit and receive data necessary for generating a first digital ID, to and from an external device (e.g., the data subject terminal or the second node). The first communication unit 211 may serve to transmit information processed by the first node 120 to the external device. In addition, the first communication unit 211 may include hardware and software necessary for transmitting and receiving signals, such as control signals or data signals, through wired or wireless connections with other network devices.

The encryption unit 212 may receive a unique identification value of a data subject, and an identity generation sequence, from a data subject terminal through the first communication unit 211. Here, the unique identification value of the data subject may include personally identifiable information for identifying the data subject, and a service identification sequence generated based on a service specified by the data subject terminal.

The encryption unit 212 may concatenate the unique identification value 303 of the data subject with an identity generation sequence 304, and encrypt the unique identification value 303 of the data subject that is concatenated with the identity generation sequence 304 to generate a de-identified unique identification value 305 of the data subject (see FIG. 3).

In an embodiment, the encryption unit 212 may generate a de-identified unique identification value of the data subject by concatenating the unique identification value of the data subject with the identity generation sequence in a preset manner, and encrypting a resulting value of the concatenation through a preset encryption algorithm (e.g., SHA-256). At this time, the encryption unit 212 may generate a de-identified unique identification value Temp of the data subject according to [Equation 1].

$$Temp = {HMAC}_{sk} ( RN \vert \vert SEQ ) \qquad [ Equation 1 ]$$

Here, RN (random number) may denote the unique identification value of the data subject. SEQ denotes one or more identity generation sequences, and is the information used in the process of encrypting the unique identification value of the data subject.

Identity generation sequences may be generated by the data subject terminal, and may be generated as many as the number of digital IDs. For example, when five digital IDs are to be generated by using one unique identification value of the data subject, the number of identity generation sequences may be 5.

The first digital identity generation unit 213 may generate pseudorandom number 306 based on a counter value that is generated based on the current time, and a seed value that is generated according to a preset criterion, and generate a first digital ID 307 based on the de-identified unique identification value 305 of the data subject received from the encryption unit 212, and the generated pseudorandom numbers 306.

In an embodiment, the first digital identity generation unit 213 may include a counter value generation unit, a pseudorandom number generation unit, and a digital identity computation unit.

The counter value generation unit may generate a counter value based on the current time, and provide the counter value to the pseudorandom number generation unit.

The pseudorandom number generation unit may operate, for example, in a time-based one-time password (OTP) manner, and may generate pseudorandom numbers for a particular time point based on a time-based counter value and a seed value that is generated according to a preset criterion. At this time, the pseudorandom number generation unit may generate pseudorandom numbers (PRN) for a particular time point according to [Equation 2].

$$PRN = truncate ( HMAC ( K , {C}_{T} ) ) mod {10}^{d} \qquad [ Equation 2 ]$$

Here, K denotes the seed value and d denotes the number of digits of the pseudorandom numbers.

In addition, CT denotes a counter value at a time point T and may be generated by the counter value generation unit according to [Equation 3].

$${C}_{T} = ⌊ \frac{{T}_{C} - {T}_{O}}{{T}_{I}} ⌋ \qquad [ Equation 3 ]$$

Here, Tc denotes the current time and T_{O} denotes a Unix time when a time interval count starts, and may be set to ‘0’ as default. T_{I} denotes a time interval used to calculate the counter value, i.e., a period.

The pseudorandom number generation unit may update the pseudorandom numbers based on the changing counter value. Here, the counter value increases based on the passage of time, but may be changed according to the preset period T_{I}.

The digital identity computation unit may generate a first digital ID based on the de-identified unique identification value of the data subject, and the pseudorandom numbers. At this time, the digital identity computation unit may generate the first digital ID according to [Equation 4].

$$Digital ID = H ( Temp \vert \vert PRN ) \qquad [ Equation 4 ]$$

Here, Temp denotes the de-identified unique identification value of the data subject, and pseudorandom numbers (PRN) denotes pseudorandom numbers.

The digital identity computation unit may update the first digital ID based on the pseudorandom numbers that are updated based on the counter value that changes according to the preset period T_{I}. That is, the digital identity computation unit may update the first digital ID at every preset period T_{I}.

For example, assuming that the first digital ID was generated at 17:00:00 on Feb. 1, 2023, the Unix time T_{O} at which a time interval count starts is 1675238400, and assuming that the current time is 14:00:00 on Jun. 1, 2023, the current time T_{O} is 1685595600. When an update interval is 30 minutes, the counter value C_{T} at the current time point may be generated as 5754 according to [Equation 3].

In an embodiment, the first digital identity generation unit 213 may transmit, to the second node 130 through the first communication unit 211, the de-identified unique identification value of the data subject that is generated by the encryption unit 212, and the seed value used for generating the pseudorandom numbers.

The first processor 214 is connected to the first communication unit 211, the encryption unit 212, the first digital identity generation unit 213, and the first memory 215 and controls them, thereby processing the overall operation of the first node 120.

The first memory 215 may perform a function of temporarily or permanently storing information processed by the first communication unit 211, the encryption unit 212, the first digital identity generation unit 213, and the first processor 214. The first memory 215 may store, for example, a unique identification value of a data subject, a de-identified unique identification value of the data subject, a seed value, a first digital ID, etc.

The first memory 215 may be equipped with software for a series of processes performed by the first processor 214.

The second node 130 communicating with the first node 120 may include a second communication unit 221, a second digital identity generation unit 222, a second processor 223, and a second memory 224.

The second communication unit 221 may transmit and receive data necessary for generating a second digital ID, to and from an external device (e.g., the data subject terminal or the first node). In addition, the second communication unit 221 may serve to verify the validity of a second digital ID, and transmit information processed by the second node 130 to an external device.

The second digital identity generation unit 222 may receive, from the first node 120 through the second communication unit 221, a de-identified unique identification value of a data subject, and a seed value. The second digital identity generation unit 222 may generate pseudorandom numbers based on a counter value that is generated based on the current time, and the seed value, and generate a second digital ID based on the de-identified unique identification value of the data subject received from the first node 120, and the generated pseudorandom numbers.

In an embodiment, the second digital identity generation unit 222 may include a counter value generation unit, a pseudorandom number generation unit, and a digital identity computation unit.

The counter value generation unit may generate a counter value based on the current time, and provide the counter value to the pseudorandom number generation unit. At this time, the counter value generation unit may generate the counter value according to [Equation 3].

The pseudorandom number generation unit may operate, for example, in a time-based password (OTP) manner, and may generate pseudorandom numbers for a particular time point based on a time-based counter value and the seed value that is received from the first node 120. At this time, the pseudorandom number generation unit may generate pseudorandom numbers (PRN) for a particular time point according to [Equation 2].

The pseudorandom number generation unit may update the pseudorandom numbers based on the changing counter value. Here, the counter value increases based on the passage of time, but may be changed according to the preset period T_{I}.

The digital identity computation unit may generate a second digital ID based on the de-identified unique identification value of the data subject, and the pseudorandom numbers. At this time, the digital identity computation unit may generate the second digital ID according to [Equation 4].

The digital identity computation unit may update the second digital ID based on the pseudorandom numbers that are updated based on the counter value that changes according to the preset period T_{I}. That is, the digital identity computation unit may update the second digital ID at every preset period T_{I}, like the first digital ID.

The second processor 223 is connected to the second communication unit 221, the second digital identity generation unit 222, and the second memory 224 and controls them, thereby processing the overall operation of the second node 130.

In an embodiment, for example, the first processor 214 and the second processor 223 may refer to a hardware-embedded data processing device having a physically structured circuitry to perform functions represented by code or instructions included in a program. Examples of the hardware-embedded data processing device may include a processing device, such as a microprocessor, a central processing unit (CPU), a processor core, a multiprocessor, an application-specific integrated circuit (ASIC), and a field-programmable gate array (FPGA), but the present disclosure is not limited thereto.

The second memory 224 may perform a function of temporarily or permanently storing information processed by the second communication unit 221, the second digital identity generation unit 222, and the second processor 223. The second memory 224 may store, for example, a de-identified unique identification value of a data subject, a seed value, a second digital ID, etc.

The second memory 224 may be equipped with software for a series of processes performed by the second processor 223.

In an embodiment, the first memory 215 and the second memory 224 may include magnetic storage media or flash storage media, but the present disclosure is not limited thereto. The first memory 215 may include an internal memory and/or an external memory, and may include a volatile memory, such as dynamic random-access memory (DRAM), static random-access memory (SRAM), or synchronous DRAM (SDRAM), nonvolatile memory such as a one-time programmable read-only memory (OTPROM), programmable read-only memory (PROM), erasable programmable read-only memory (EPROM), electrically erasable programmable read-only memory (EEPROM), mask read-only memory (ROM), flash ROM, NAND flash memory, or NOR flash memory, a flash drive such as a solid-state drive (SSD), a compact flash (CF) card, a Secure Digital (SD) card, a Micro-SD card, a Mini-SD card, an extreme Digital (XD) card, or a memory stick, or a storage device, such as a hard disk drive (HDD).

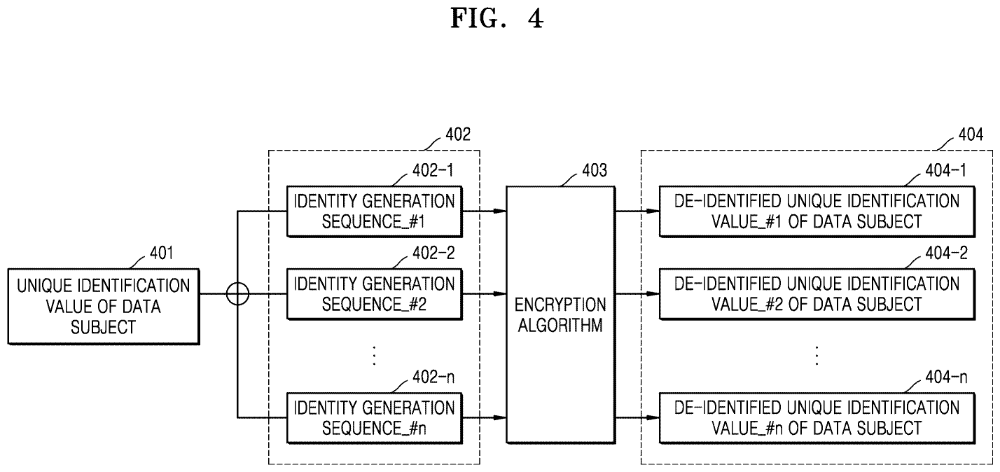

FIG. 4 is a diagram for describing an example of generating a de-identified unique identification value for a data subject within a digital identity system, according to an embodiment of the present disclosure.

In FIG. 4, an encryption unit included in a node of the digital identity system may receive a unique identification value of a data subject, and an identity generation sequence, and generate a de-identified unique identification value of the data subject based on the unique identification value of the data subject, and the identity generation sequence.

Here, the unique identification value of the data subject may include a service identification sequence and personally identifiable information, and may have, for example, a size of 104 bits. The number of identity generation sequences may be, for example, n (n is a natural number), and each identity generation sequence may have, for example, a size of 128 bits. In addition, the number of de-identified unique identification values of the data subject may be n (n is a natural number), and each de-identified unique identification value may have, for example, a size of 256 bits. The n de-identified unique identification values of the data subject may be different from each other.

The encryption unit may generate de-identified unique identification values 404 of the data subject by concatenating a unique identification value 401 of the data subject with a multi-identity generation sequence 402 in a preset manner, and encrypting a resulting value of the concatenation based on a preset secret key through an encryption algorithm 403 (e.g., SHA-256). At this time, the encryption unit may generate a de-identified unique identification value_#1 404-1 of the data subject by concatenating the unique identification value 401 of the data subject with an identity generation sequence_#1 402-1, and encrypting a resulting value of the concatenation. In addition, the encryption unit may generate a de-identified unique identification value_#n 404-n of the data subject by concatenating the unique identification value 401 of the data subject with an identity generation sequence_#n 402-n, and encrypting a resulting value of the concatenation.

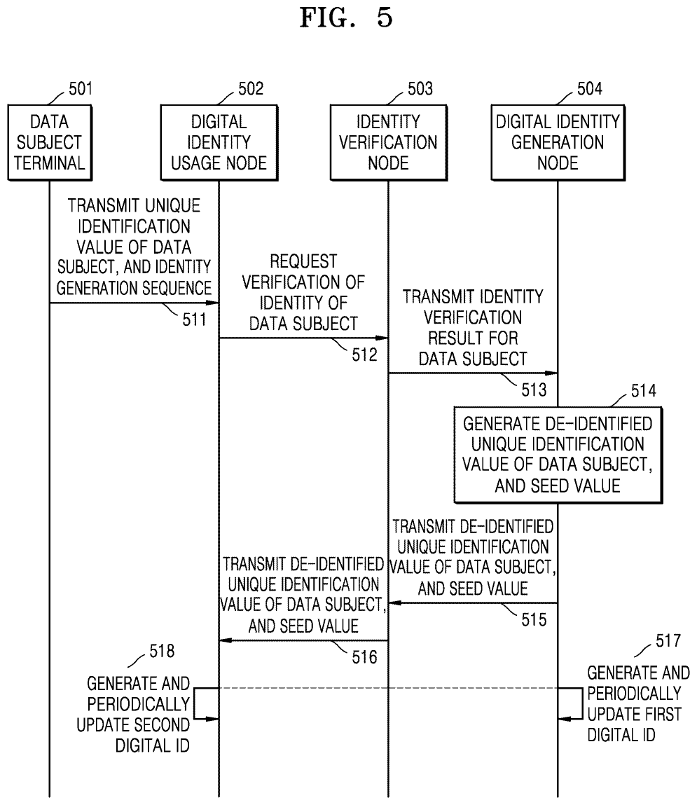

Hereinafter, an example of an operation method of a digital identity system will be described with reference to FIGS. 5 to 9. In the following description, redundant descriptions are provided above with reference to FIGS. 1 to 4 will be omitted.

FIG. 5 is a message flow diagram for describing an example of an operation method of a digital identity system, according to the present embodiment. In this embodiment, the digital identity system is centralized and may include a data subject terminal, a digital identity usage node, an identity verification node, and a digital identity generation node. Because the centralized system is based on the premise of identity verification of a data subject, the data subject terminal may delegate the functions of generating de-identified unique identification values and seed values, to the digital identity generation node.

Referring to FIG. 5, a data subject terminal 501 may transmit, to a digital identity usage node 502, a unique identification value of a data subject, and an identity generation sequence (511).

Based on receiving the unique identification value of the data subject and the identity generation sequence from the data subject terminal 501, the digital identity usage node 502, as an online service provider, may transmit, to an identity verification node 503, an identity verification request for the data subject along with the unique identification value of the data subject (512).

Based on preset unique identification values for respective data subjects, the identity verification node 503 may verify the identity of the data subject based on the unique identification value of the data subject received from the digital identity usage node 502. The identity verification node 503 may transmit, to a digital identity generation node 504, an identity verification result along with the unique identification value of the data subject, and the identity generation sequence (513).

The digital identity generation node 504 may receive, from the identity verification node 503, the identity verification result along with the unique identification value of the data subject, and the identity generation sequence. When the identity of the data subject is confirmed (verified) as a result of the identity verification, the digital identity generation node 504 may generate a de-identified unique identification value of the data subject based on the unique identification value of the data subject, and the identity generation sequence, and generate a seed value according to a preset criterion (514).

The digital identity generation node 504 may transmit, to the identity verification node 503, the de-identified unique identification value of the data subject, and the seed value (515).

The identity verification node 503 may receive the de-identified unique identification value of the data subject, and the seed value from the digital identity generation node 504, and then transmit them to the digital identity usage node 502.

The digital identity generation node 504 may generate a first digital ID based on the de-identified unique identification value of the data subject, and the seed value, and update the first digital ID at every preset period (517). At this time, the digital identity generation node 504 may generate a counter value based on the current time, generate pseudorandom numbers based on the counter value and the seed value, and generate the first digital ID based on the de-identified unique identification value of the data subject, and the pseudorandom numbers.

In addition, the digital identity usage node 502 may receive, from the identity verification node 503, the de-identified unique identification value of the data subject, and the seed value, and generate a second digital ID based on the de-identified unique identification value of the data subject, and the seed value. The digital identity usage node 502 may update the second digital ID at every preset period (518). At this time, the digital identity generation node 504 may generate a counter value based on the current time, generate pseudorandom numbers based on the counter value and the seed value, and generate the second digital ID based on the de-identified unique identification value of the data subject, and the pseudorandom numbers.

In an embodiment, the digital identity usage node 502 and the digital identity generation node 504 may include temporally synchronized digital identity generation units, respectively, and may generate and update a second digital ID and a first digital ID through the digital identity generation units.

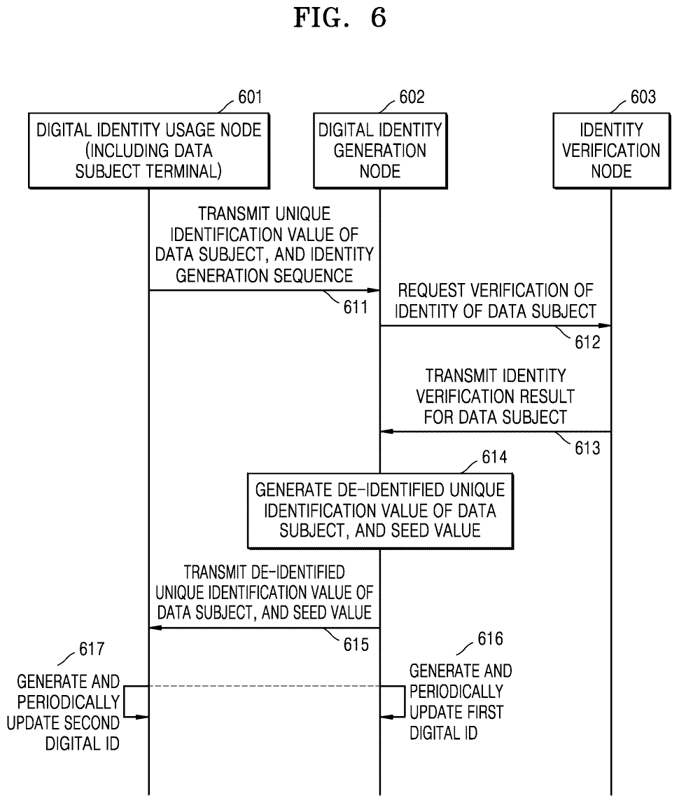

FIG. 6 is a message flow diagram for describing another example of an operation method of a digital identity system, according to the present embodiment. Here, the digital identity system is a decentralized distributed system and may include a digital identity usage node, a digital identity generation node, and an identity verification node. In the decentralized distributed system, every node may be a data subject terminal, a digital identity generation node, or a digital identity usage node. Here, when identity verification for a data subject is required, the decentralized distributed system may request identity verification from the identity verification node, and delegate the functions of generating a de-identified unique identification value to a digital identity generation node, to the digital identity generation node.

Referring to FIG. 6, a digital identity usage node 601 may include a data subject terminal, and may receive an input of a unique identification value of a data subject, and an identity generation sequence through the data subject terminal.

The digital identity usage node 601 may transmit, to a digital identity generation node 602, the unique identification value of the data subject, and the identity generation sequence (611).

Based on receiving the unique identification value of the data subject and the identity generation sequence from the digital identity usage node 601, the digital identity generation node 602 may transmit, to an identity verification node 603, an identity verification request for the data subject along with the unique identification value of the data subject (612).

Based on preset unique identification values for respective data subjects, the identity verification node 603 may verify the identity of the data subject based on the unique identification value of the data subject received from the digital identity generation node 602. The identity verification node 603 may transmit an identity verification result to the digital identity generation node 602 (613).

The digital identity generation node 602 may receive, from the identity verification node 603, the identity verification result for the data subject. When the identity of the data subject is confirmed (verified) as a result of the identity verification, the digital identity generation node 602 may generate a de-identified unique identification value of the data subject based on the unique identification value of the data subject, and the identity generation sequence both received from the digital identity usage node 601. In addition, the digital identity generation node 602 may generate a seed value according to a preset criterion (614).

The digital identity generation node 602 may transmit, to the digital identity usage node 601, the de-identified unique identification value of the data subject, and the seed value (615).

The digital identity generation node 602 may generate a first digital ID based on the de-identified unique identification value of the data subject, and the seed value, and update the first digital ID at every preset period (616). At this time, the digital identity generation node 602 may generate a counter value based on the current time, generate pseudorandom numbers based on the counter value and the seed value, and generate the first digital ID based on the de-identified unique identification value of the data subject, and the pseudorandom numbers.

The digital identity usage node 601 may receive, from the digital identity generation node 602, the de-identified unique identification value of the data subject, and the seed value, and generate a second digital ID based on the de-identified unique identification value of the data subject, and the seed value. The digital identity usage node 601 may update the second digital ID at every preset period (617). At this time, the digital identity usage node 601 may generate a counter value based on the current time, generate pseudorandom numbers based on the counter value and the seed value, and generate the second digital ID based on the de-identified unique identification value of the data subject, and the pseudorandom numbers.

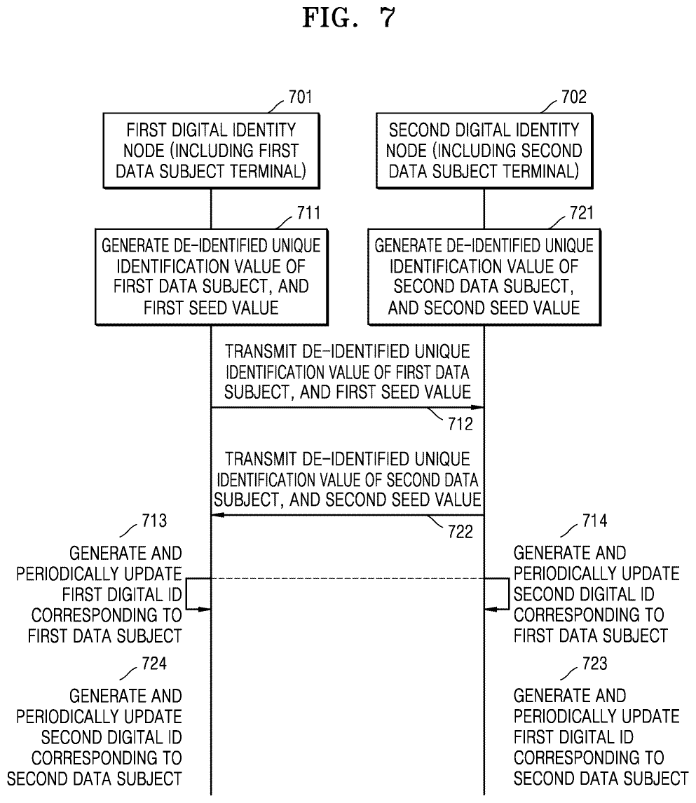

FIG. 7 is a message flow diagram for describing another example of an operation method of a digital identity system, according to the present embodiment. Here, the digital identity system is a decentralized distributed system and may include a first digital identity node and a second digital identity node. In addition, the first digital identity node may include a first digital identity usage node and a first digital identity generation node, and the second digital identity node may include a second digital identity usage node and a second digital identity generation node. In the decentralized distributed system, every node may be a data subject terminal, a digital identity generation node, or a digital identity usage node. Here, the decentralized distributed system may not require identity verification of a data subject, unlike in FIG. 6. Every node may de-identify its own unique identification value and transmit the de-identified unique identification value along with a seed value directly to other nodes. The other nodes that have received the de-identified unique identification value and the seed value may generate and update a digital ID through a digital identity generation unit.

Referring to FIG. 7, a first digital identity node 701 may include a first data subject terminal, and may receive, through the first data subject terminal, an input of a unique identification value of a first data subject, and a first identity generation sequence (one or more first identity generation sequences).

The first digital identity generation node of the first digital identity node 701 may generate a de-identified unique identification value of the first data subject based on the unique identification value of the first data subject, and the first identity generation sequence. In addition, the first digital identity generation node may generate a first seed value according to a preset criterion (711).

The first digital identity node 701 may transmit, to a second digital identity node 702, the de-identified unique identification value of the first data subject, and the first seed value (712).

The first digital identity generation node of the first digital identity node 701 may generate a first digital ID corresponding to the first data subject, based on the de-identified unique identification value of the first data subject, and the first seed value, and update the first digital ID at every preset period (713).

The second digital identity node 702 may receive, from the first digital identity node 701, the de-identified unique identification value of the first data subject, and the first seed value. The second digital identity usage node of the second digital identity node 702 may generate a second digital ID corresponding to the first data subject, based on the de-identified unique identification value of the first data subject, and the first seed value, and update the second digital ID at every preset period (714).

The second digital identity node 702 may include a second data subject terminal, and may receive, through the second data subject terminal, an input of a unique identification value of a second data subject, and a second identity generation sequence (one or more second identity generation sequences).

The second digital identity generation node of the second digital identity node 702 may generate a de-identified unique identification value of the second data subject based on the unique identification value of the second data subject, and the second identity generation sequence. In addition, the second digital identity generation node may generate a second seed value according to a preset criterion (721).

The second digital identity node 702 may transmit, to the first digital identity node 701, the de-identified unique identification value of the second data subject, and the second seed value (722).

The second digital identity generation node of the second digital identity node 702 may generate a second digital ID corresponding to the second data subject, based on the de-identified unique identification value of the second data subject, and the second seed value, and update the second digital ID at every preset period (723).

The first digital identity node 701 may receive, from the second digital identity node 702, the de-identified unique identification value of the second data subject, and the second seed value. The first digital identity usage node of the first digital identity node 701 may generate a second digital ID corresponding to the second data subject, based on the de-identified unique identification value of the second data subject, and the second seed value, and update the second digital ID at every preset period (724).

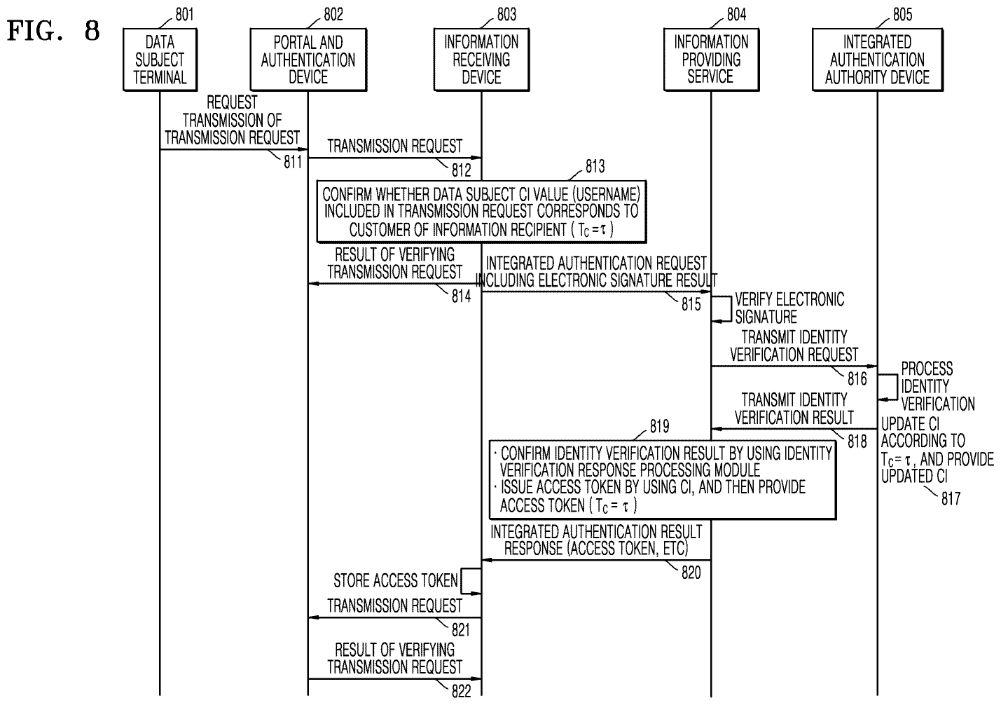

FIG. 8 is a message flow diagram for describing another example of an operation method of a digital identity system, according to the present embodiment. Here, the digital identity system may include a plurality of nodes, for example, a data subject terminal, a portal and authentication device, an information receiving device (including a digital identity usage node), an information providing device (including a digital identity usage node), and an integrated authentication authority device (including a digital identity generation node and an identity verification node). Each node included in the digital identity system may generate and store in a memory, for example, data subject connecting information (CI) (e.g., a username) as a digital ID, and update the data subject CI at every preset period by itself.

Referring to FIG. 8, in order to use a service a data subject terminal 801 may transmit, to a portal and authentication device 802, a request for transmission of a transmission request along with personally identifiable information (e.g., a resident registration number or a social security number) about the data subject (811). By transmitting a request for transmission of a transmission request, the data subject terminal 801 allows an information provider (e.g., the portal and authentication device 802) that has stored information about the data subject in advance to transmit the information about the data subject (e.g., data subject CI) to an information receiving device 803.

The portal and authentication device 802 may transmit a pre-stored transmission request to the information receiving device 803 (812).

The information receiving device 803 may receive the transmission request from the portal and authentication device 802, and verify the received transmission request. At this time, the information receiving device 803 may verify the transmission request by confirming whether data subject CI included in the transmission request corresponds to a customer of the information recipient (T_{C}=T) (813), and transmit, to the portal and authentication device 802, a result of verifying the transmission request (814).

In addition, the information receiving device 803 may transmit, to an information providing device 804, an integrated authentication request including an electronic signature result (a verification result for the transmission request) (815).

The information providing device 804 may be, for example, a bank server that uses a MyData service, and it may verify an electronic signature and transmit an identity verification request to an integrated authentication authority device 805 (816).

The integrated authentication authority device 805 may process identity verification by updating the data subject CI according to T_{C}=T (e.g., updating the data subject CI) (817), and transmit an identity verification result to the information providing device 804 (818). Here, when transmitting the identity verification result, the integrated authentication authority device 805 may transmit the data subject CI to the information providing device 804. Here, the integrated authentication authority device 805 may perform identity verification by using, for example, a resident registration number.

The information providing device 804 may confirm the identity verification result by using an identity verification response processing module, issue an access token by using the data subject CI, and then provide the information receiving device 803 with the access token along with the data subject CI (T_{C}=T) (819). At this time, the information providing device 804 may extract data subject CI from an integrated authentication result response, and when the extracted data subject CI coincides with the data subject CI (the data subject CI updated at Tc) that is pre-stored in a memory of the information providing device 804, determines that the pre-stored data subject CI is valid. The information providing device 804 may transmit the integrated authentication result response to the information receiving device 803 (820). That is, the information providing device 804 may update the pre-stored data subject CI over time, verify the data subject CI by comparing it with the data subject CI received from the integrated authentication authority device 805 (received via 817 and 818), issue an access token, and provide the access token to the information receiving device 803.

The information receiving device 803 may transmit a transmission request to the portal and authentication device 802 (821), and receive a result of verifying the transmission request from the portal and authentication device 802. At this time, when the data subject CI confirmed from the result of verifying the transmission request (or the data subject CI pre-stored in the memory of the information receiving device 803 (the data subject CI updated at Tc)) coincides with the data subject CI received from the information providing device 804, the information receiving device 803 may determine that the data subject CI confirmed from the result of verifying the transmission request (or the pre-stored data subject CI) is valid. When it is determined that the data subject CI is valid, the information receiving device 803 may request the MyData service from the portal and authentication device 802 supporting the MyData service, and receive and output MyData service information from the portal and authentication device 802 as a response to the request.

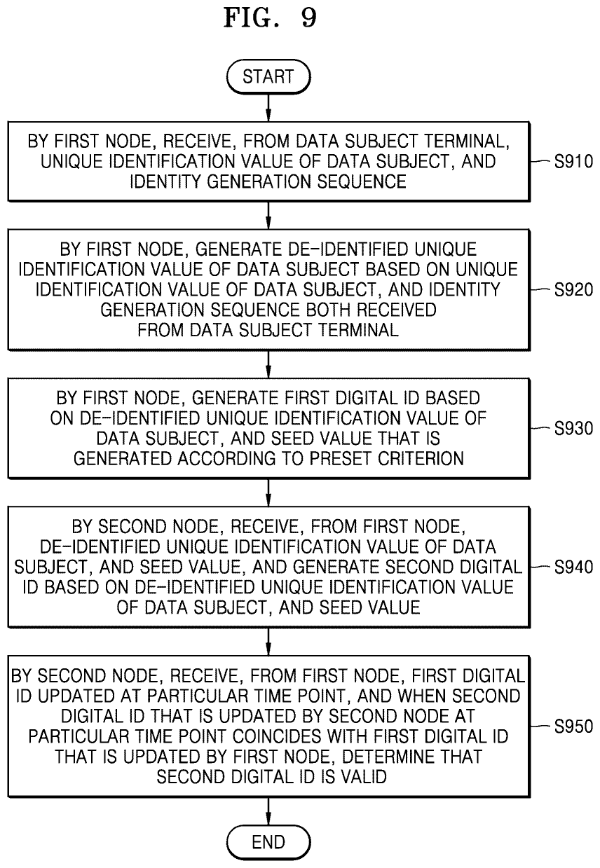

FIG. 9 is a flowchart of an operation method of a digital identity system according to an embodiment of the present disclosure. Here, the digital identity system may include a data subject terminal, a first node, and a second node.

Referring to FIG. 9, in operation S910, the first node may receive, from the data subject terminal, a unique identification value of a data subject, and an identity generation sequence. The unique identification value of the data subject may include personally identifiable information for identifying the data subject, and a service identification sequence generated based on a service specified by the data subject terminal.

In operation S920, the first node may generate a de-identified unique identification value of the data subject based on the unique identification value of the data subject, and the identity generation sequence both received from the data subject terminal. At this time, the first node may generate the de-identified unique identification value of the data subject by using an encryption unit to concatenate the unique identification value of the data subject with the identity generation sequence, and encrypt the unique identification value of the data subject concatenated with the identity generation sequence.

In operation S930, the first node may generate a first digital ID based on the de-identified unique identification value of the data subject, and a seed value that is generated according to a preset criterion. At this time, the first node may generate pseudorandom numbers based on a counter value that is generated based on the current time, and the seed value through a first digital identity generation unit, and generate the first digital ID based on the de-identified unique identification value of the data subject, and the pseudorandom numbers. The first node may store the first digital ID in a memory and update it at every preset period.

In operation S940, the second node may receive, from the first node, the de-identified unique identification value of the data subject, and the seed value, and generate a second digital ID based on the de-identified unique identification value of the data subject, and the seed value. At this time, the second node may generate pseudorandom numbers based on a counter value that is generated based on the current time, and the seed value through a second digital identity generation unit, and generate the second digital ID based on the de-identified unique identification value of the data subject, and the pseudorandom numbers. The second node may store the second digital ID in a memory and update it at every preset period.

In an embodiment, the counter values used by the first and second digital identity generation units increase based on the passage of time, but may be changed according to a preset period. As the counter values change, the pseudorandom numbers may be updated, and as the pseudorandom numbers are updated, the first and second digital IDs may be updated. That is, the first and second digital IDs may be updated in conjunction with the period in which the counter values change.

In operation S950, the second node may transmit, to the first node, a verification request for the second digital ID corresponding to the data subject, and receive, from the first node, the first digital ID corresponding to the data subject and updated at a particular time point, as a response to the verification request. When the second digital ID updated by the second node at a particular time point coincides with the first digital ID updated by the first node, the second node may determine that the second digital ID is valid. Thereafter, based on determining that the second digital ID is valid, the second node provides the data subject terminal with service information supported by the second node (or another node), to allow the data subject to utilize the service information.

A digital identity system according to an embodiment of the present disclosure enables the generation of a digital ID at each node while limiting leakage of a unique identification value of a data subject that is not encrypted, by allowing a first node to generate a de-identified unique identification value of the data subject by encrypting the unique identification value of the data subject that is received from a data subject terminal, and generate a first digital ID based on the de-identified unique identification value of the data subject, and by allowing a second node to generate a second digital ID based on the de-identified unique identification value of the data subject shared by the first node.

The digital identity system according to an embodiment of the present disclosure allows the first and second nodes to update their first and second digital IDs at every preset period, respectively, thereby enabling each node to maintain a valid digital ID, and preventing a chain of personal information leaks even when a previous digital ID is leaked.

In the digital identity system according to an embodiment of the present disclosure, the second node receives the first digital ID updated by the first node at a particular time point, and determines, when the second digital ID is updated by the second node at a particular time point coincides with the first digital ID, that the second digital ID is valid, and thus provides service information supported by the second node (or another node), to a data subject terminal associated with the second digital ID, thereby enabling the data subject to use the service information.

In addition, in the digital identity system according to an embodiment of the present disclosure, as the unique identification value of a data subject provided by a data subject terminal includes personally identifiable information and a service identification sequence for identifying a service, the first node generates, based on the unique identification value of the data subject, digital IDs differently for respective services, thereby significantly reducing the possibility of tracing a digital identity of the data subject.

The embodiments of the present disclosure described above may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a compact disc read-only memory (CD-ROM) or a digital video disc (DVD), a magneto-optical medium, such as a floptical disk, and a hardware device specially configured to store and execute program instructions, such as ROM, random-access memory (RAM), or flash memory.

Meanwhile, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

The term ‘the’ and other demonstratives similar thereto in the specification of the present disclosure (especially in the following claims) should be understood to include a singular form and plural forms. Furthermore, recitation of ranges of values herein is merely intended to serve as a shorthand method of referring individually to each separate value falling within the range, unless otherwise indicated herein, and each separate value is incorporated into the specification as if it were individually recited herein.

The operations of the methods according to the present disclosure may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as failing within the scope of the present disclosure.

According to the present disclosure, there may be provided a digital identity system and an operation method of the digital identity system, for enabling the generation of a digital ID at each node while limiting leakage of a unique identification value of a data subject that is not encrypted, by allowing a first node to generate a de-identified unique identification value of the data subject by encrypting the unique identification value of the data subject that is received from a data subject terminal, and generate a first digital ID based on the de-identified unique identification value of the data subject, and by allowing a second node to generate a second digital ID based on the de-identified unique identification value of the data subject shared by the first node.

According to the present disclosure, the first and second nodes update their first and second digital IDs at every preset period, respectively, thereby enabling each node to maintain a valid digital ID, and preventing a chain of personal information leaks even when a previous digital ID is leaked.

According to the present disclosure, the second node receives the first digital ID updated by the first node at a particular time point, determines, when the second digital ID updated by the second node at a particular time point coincides with the first digital ID, that the second digital ID is valid, and thus provides service information supported by the second node (or another node), to a data subject terminal associated with the second digital ID, thereby enabling the data subject to use the service information.

In addition, according to the present disclosure, as a unique identification value of a data subject provided by a data subject terminal includes personally identifiable information and a service identification sequence for identifying a service, the first node generates, based on the unique identification value of the data subject, digital IDs differently for respective services, thereby significantly reducing the possibility of tracing a digital identity of the data subject. By generating a plurality of digital IDs in correspondence with the data subject, it is possible to resolve the inconvenience of having to redundantly obtain digital IDs issued by a plurality of service providers.

Effects of the present disclosure are not limited to the foregoing, and other unmentioned effects would be clearly understood by those skilled in the art from the following description.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A digital identity system comprising:
a first node configured to generate a de-identified unique identification value of a data subject based on a unique identification value of the data subject and an identity generation sequence which are received from a data subject terminal, and generate a first digital identity (ID) based on the de-identified unique identification value of the data subject, and a seed value that is generated according to a preset criterion; and
a second node configured to receive, from the first node, the de-identified unique identification value of the data subject, and the seed value, and generate a second digital ID based on the de-identified unique identification value of the data subject, and the seed value.

2. The digital identity system of claim 1, wherein the first digital ID and the second digital ID are updated at every preset period.

3. The digital identity system of claim 1, wherein the second node is further configured to transmit, to the first node, a verification request for the second digital ID corresponding to the data subject, receive, from the first node, the first digital ID corresponding to the data subject that is updated at a particular time point, as a response to the verification request, and based on the second digital ID updated at the particular time point coinciding with the updated first digital ID, determine that the second digital ID is valid.

4. The digital identity system of claim 1, wherein the first node comprises an encryption unit configured to concatenate the unique identification value of the data subject with the identity generation sequence, and encrypt the unique identification value of the data subject concatenated with the identity generation sequence to generate the de-identified unique identification value of the data subject.

5. The digital identity system of claim 4, further comprising a first digital identity generation unit configured to generate pseudorandom numbers based on the seed value and a counter value that is generated based on a current time, and generate the first digital ID based on the de-identified unique identification value of the data subject, and the pseudorandom numbers.

6. The digital identity system of claim 1, wherein the unique identification value of the data subject comprises personally identifiable information for identifying the data subject, and a service identification sequence that is generated based on a service specified by the data subject terminal.

7. The digital identity system of claim 1, wherein the second node comprises a second digital identity generation unit configured to generate pseudorandom numbers based on the seed value and a counter value that is generated based on a current time, and generate the second digital ID based on the de-identified unique identification value of the data subject, and the pseudorandom numbers.

8. The digital identity system of claim 5, wherein the counter value increases based on the passage of time and is changed according to a preset period.

9. The digital identity system of claim 7, wherein the counter value increases based on the passage of time and is changed according to a preset period.

10. An operation method performed by a digital identity system, the operation method comprising:
by a first node in the digital identity system, generating a de-identified unique identification value of a data subject based on a unique identification value of the data subject and an identity generation sequence which are received from a data subject terminal, and generating a first digital identity (ID) based on the de-identified unique identification value of the data subject, and a seed value that is generated according to a preset criterion; and
by a second node in the digital identity system, receiving, from the first node, the de-identified unique identification value of the data subject, and the seed value, and generating a second digital ID based on the de-identified unique identification value of the data subject, and the seed value.
